(19) United States
(12) Patent Application Publication
(10) Pub. No.: US 2007/0273909 A1
(43) Pub. Date: Nov. 29, 2007

(54) Method and system for providing job listing affinity utilizing jobseeker selection patterns

(75) Inventors: Changsheng Chen, Hayward, CA (US); Adam Hyder, Los Altos, CA (US)

Correspondence Address: GREENBERG TRAURIG, LLP, MET LIFE BUILDING, 200 PARK AVENUE, NEW YORK, NY, 10166, US

(73) Assignee: YAHOO! Inc., Sunnyvale, CA (US)

(21) Appl. No.: 11/442,443

(22) Filed: May 25, 2006

(51) Int. Cl. G06F 3/12

(52) U.S. Cl. 358/1.13; 358/3.22

(57) ABSTRACT

A method and system of establishing affinity of job listings is disclosed. A first job listing for which a jobseeker has applied is determined. The first job listing has a first job attribute. A second job listing for which the jobseeker has applied is also determined. The second job listing has a second job attribute. A first job attribute value and a second job attribute value are compared to determine a similarity score that represents a similarity between the first job attribute and the second job attribute. The first job listing and the second job listing are affiliated if the similarity score is higher than a predefined threshold level.

### BACKGROUND

1. Field

This disclosure relates to systems and method for establishing affinity of two job listings utilizing job listing attributes and jobseeker selection patterns.

2. General Background

Various search engines are available to users who view, apply for, request, purchase, and subscribe to items offered on World Wide Web and other information sharing infrastructures. In addition, the exponential growth of the number of items offered on the World Wide Web can frustrate and confuse users when attempting to locate a needed item.

In particular, jobseekers can be assisted if job listing services recommend relevant job listings which have been determined to have an affinity with jobs previously applied for by the jobseeker. By doing this, jobseekers, employers, and job listing services benefit. The jobseeker has a more pleasant experience and may quickly locate a job listing that are pertinent to his needs. In addition, the employer can receive a greater number of jobseeker applications for a particular job.

### SUMMARY

In one aspect, there is a method of establishing affinity of job listings. A first job listing for which a jobseeker has applied is determined. The first job listing has a first job attribute. A second job listing for which the jobseeker has applied is also determined. The second job listing has a second job attribute. A first job attribute value and a second job attribute value are compared to determine a similarity score that represents a similarity between the first job attribute and the second job attribute. The first job listing and the second job listing are affiliated if the similarity score is higher than a predefined threshold level.

The second job listing can be recommended to a new jobseeker when the new jobseeker applies for the first job listing, if the similarity score is higher than the predefined threshold level. The first job listing can be recommended to a new jobseeker when the new jobseeker applies for the second job listing, if the similarity score is higher than the predefined threshold level.

In a further aspect of the method, a weight corresponding to the first and the second attribute can be generated and multiplied by the similarity score. Alternatively, the similarity score can be multiplied by a weight defined by the jobseeker.

In a further aspect of the method, the predefined threshold level is received as established by the jobseeker can be determined. In another aspect, the predefined threshold level is received as established by the jobseeker. In yet another aspect, the predefined threshold level is received as established by a system operator. In another aspect, the predefined threshold level can be established as part of the method. The predefined threshold level can be zero.

In another aspect, the first job attribute value is a first job listing location, and the second job attribute value is a second job listing location. In another approach, the first job attribute value is a first job listing title, and the second job attribute value is a second job listing title. Additionally, the first job attribute value is a first job jobseeker, and the second job attribute value is a second job jobseeker.

Furthermore, if the first job attribute value and the second job attribute value are identical the similarity score is assigned a value of one. In another embodiment, if the first job attribute value and the second job attribute value are not identical the similarity score is assigned a value of zero. In yet another embodiment, if the first job attribute value and the second job attribute value are not identical the similarity score is assigned a value between zero and one. Furthermore, a predefined similarity score as the similarity score can be utilized. The predefined similarity score is indicative of the similarity of a value pair in a similarity table. The first job attribute value can be equivalent to a first element of the value pair, and the second job attribute value is equivalent to a second element of the value pair.

In another embodiment, there is a system that establishes affinity of job listings, comprising a jobs database and an affinity module. The jobs database includes a first job listing for which a jobseeker has applied. The first job listing can have a first job attribute. The jobs database can further include a second job listing for which the jobseeker has applied. The second job listing can have a second job attribute. The affinity module configured to compare the first job attribute and the second job attribute to determine a similarity score that represents a similarity between the first job attribute and the second job attribute. The affinity module further affiliates the first job listing and the second job listing if the similarity score is higher than a predefined threshold level.

A method of establishing affinity of job listings. A first job listing for which a jobseeker has selected can be identified. The first job listing having a first job primary attribute and a first job secondary attribute. A second job listing for which the jobseeker has selected can be identified. The second job listing can have a second job primary attribute and a second job secondary attribute. A first job primary attribute value and a second job primary attribute value are compared to determine a primary similarity score that represents a similarity between the first job primary attribute and the second job primary attribute. The first job primary attribute value corresponds to the first job primary attribute. The second job primary attribute value corresponds to the second job primary attribute. A first job secondary attribute value and a second job secondary attribute value are compared to determine a secondary similarity score that represents a similarity between the first job secondary attribute and the second job secondary attribute. The first job secondary attribute value corresponds to the first job secondary attribute. The second job secondary attribute value corresponds to the second job secondary attribute. The first job listing and the second job listing are affiliated if the sum of the primary similarity score and the secondary similarity score is higher than a predefined threshold level.

### DRAWINGS

By way of example, reference will now be made to the accompanying drawings.

FIGS. 1A-B illustrate systems for determining and communicating jobs affinity.

FIG. 2 illustrates a block diagram of a computing device.

FIG. 3 illustrates a flow diagram of a process of determining job affinity based on jobs selected by a jobseeker.

FIG. 4 illustrates two jobs selected by a jobseeker.

FIG. 5 illustrates an exemplary similarity table of job industries.

FIG. 6 illustrates exemplary similarity scores for a job pair.

FIG. 7 illustrates exemplary attribute weights for a list of job seekers.

FIG. 8 illustrates exemplary weighted similarity scores for a job pair.

FIGS. 9A-9D illustrate exemplary jobs listed by the job listing provider.

FIG. 10 illustrates a flow diagram for a process of determining job affinity based on jobs selected by a plurality of jobseekers.

FIG. 11 illustrates an exemplary list of jobs selected by a plurality of jobseekers.

FIGS. 12A-12C illustrate exemplary similarity scores for a plurality of job pair combinations.

FIG. 13 illustrates an exemplary job pair affinity table.

### DETAILED DESCRIPTION

The methods and systems disclosed herein are directed to establishing affinity of job listings based on jobseeker selection. Jobseeker interaction, selection and preferences can be utilized to create an affinity between job listings. Jobseeker interaction provides additional reliability to associations of job listings because jobseekers utilize human analysis and inspection before selecting job listings. In addition, jobseekers can assign a weight for one or more attributes. The weight assigned by the jobseeker represents the importance that a jobseeker gives to an attribute. For example, for a jobseeker, the location of the job may be important. Then, the weight that the jobseekers assigns to the location attribute of job listings can be a number representing great interest.

The affinity based on an attribute can be measured utilizing scores. For example, two job listings that a jobseeker has applied for, and that have a common attribute, are likely to be related and have an affinity. Thus, a similarity score for the two attributes can be established. As the two jobs listings continue to be listed by the job listing provider, and jobseekers apply for these jobs, similarity scores can continue to be calculated based on the similarity of the attributes of the jobs that jobseekers view, select, or apply for. As such, the similarity scores can continue to be recalculated based on continuous and new jobseeker interaction. Over time, the similarity scores can become increasingly accurate because of the large number of jobseekers that can contribute to defining similarity and affinity relation of these jobs.

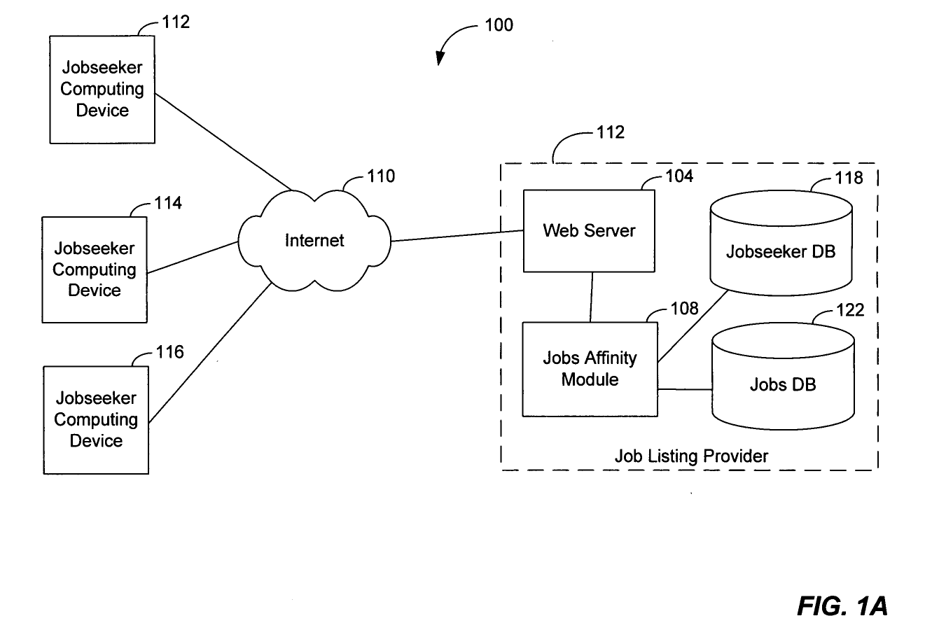

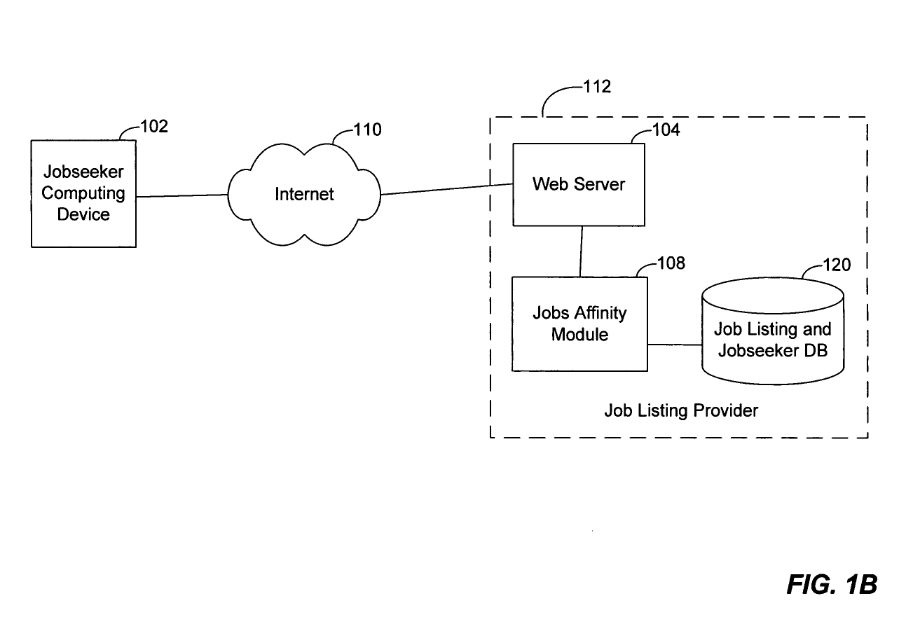

FIG. 1A illustrates systems for determining and communicating jobs affinity. The system can be configured to record jobseeker interaction with job listings and generate job affinity utilizing such jobseeker interaction. A jobseeker can select a job by accessing a job listing provider 112 through jobseeker computing devices 102, 114, and 116. The job listing provider 112 can be a job listing website, a service provider, etc. The job listing provider 112 can be accessible by multiple jobseekers who select, rate, view, or apply for jobs provided by the job listing provider 112. One or more jobseekers can communicate with the job listing provider 112 through the Internet 110 or any other communication network.

The job listing provider 112 can include a web server 104 that transmits and receives data messages with the jobseeker computing devices 102, 114, and 116. The jobseeker computing devices 102, 114, and 116, and the web server 104 can utilize communication protocols such as HTTP. A jobseeker database 118 can store jobseeker profiles which in turn can include a record of jobs previously selected by the jobseeker. The jobseeker database 118 can also store jobseeker preferences, personal information, job application patterns, resume, etc.

The job listing provider 112 further includes job listing affinity module 108 which can reside on a standalone computer. In another embodiment, the job listing affinity module 108 resides in the server 106. The job listing affinity module 108 may include logic to determine affinity between two jobs stored at the jobs database 112. The job listing affinity module 108 is further configured with logic to access, write and read data from the jobs database 122 as well as from the jobseeker database 118. Job affinity can then be utilized by the job listing affinity module 108 to formulate job recommendations and relay job recommendations to the jobseeker. In another embodiment, a recommending module (not shown) can be utilized to formulate recommendations based on job affinity.

FIG. 1B illustrates systems for determining and communicating jobs affinity, wherein a job listing and jobseeker database 118 is utilized. The job listing and jobseeker database 118 can include relational data that correlates jobseeker data and job listing data. In one example, job listing and jobseeker database 118 can be a table having a list of jobseeker identifiers. For each of the jobseeker identifiers, a corresponding list of job listing identifiers can represent the job listings that the jobseeker has selected. In another example, the job listing and jobseeker database 118 can be a table having a list of job listing identifiers. For each of the job listing identifiers, a corresponding list of jobseeker identifiers can represent the jobseekers that have selected the job listing.

The job listing job listing affinity module 108 can be configured to calculate job listing affinity according to one or more algorithms. In one embodiment, affinity of two job listings selected by a jobseeker can be established by a similarity score s(Job 1, Job 2, Aᵢ), where Aᵢ is an attribute of Job 1 and Job 2. If the similarity score s(Job 1, Job 2, Aᵢ) is greater than a predefined threshold, then Job 1 and Job 2 are affiliated. In one example, the threshold t can be between zero and one (e.g., 0<=t<=1). In another example, the threshold t can be a number within any other range. A total affinity score of two job listings can be calculated utilizing the similarity scores of all the attributes of Job 1 and Job 2. In one example, the total affinity TA can be defined by the following formula: TA=[s(Job 1, Job 2, A₁)*w₁]+[s(Job 1, Job 2, A₂)*w₂]+ . . . +[s(Job 1, Job 2, Aₙ)*wₙ], where wᵢ corresponds to the weight that a jobseeker or system operator or administrator has established to attribute Aᵢ. In another example, the total affinity TA can be defined by the following formula: TA=s(Job 1, Job 2, A₁)+[s(Job 1, Job 2, A₂)+ . . . +s(Job 1, Job 2, Aₙ).

Furthermore, a normalized total affinity can be provided according to the following formula: TA_{N}=(TA₁₋₂/U_{Job1}+TA₁₋₂/U_{Job2})/2, where U_{Job1} is the number of jobseekers interested in Job 1, and U_{Job2} is the number of jobseekers interested in Job 2.

In another embodiment, the affinity of two job listings that have been selected by multiple jobseekers is established by another algorithm. For example, jobseekers₁ . . . jobseekersₙ are interested in Job 1 and Job 2. For a jobseeker, jobseekersₖ, a similarity score s(k, Job 1, Job 2, A₁) can be calculated based on a first attribute A₁. Again, if the similarity score s(k, Job 1, Job 2, A₁) is greater than a predefined threshold, then Job 1 and Job 2 are affiliated. In one example, if the similarity score is greater than a threshold t, then Job 1 and Job 2 are affiliated through jobseekersₖ. Again, the threshold t can be established to be any number and can be within any range. For example, the threshold t can be between zero and one, e.g., 0<=t<=1. In addition, if the threshold can be for example 0.5. The threshold is can be set by a system operator or administrator, or by a user, or programmatically, or by some combination thereof.

In one embodiment, the total similarity score of Jobs 1 and Job 2 on attribute A₁ for all jobseekers is the sum of s(k, Job 1ₖ, Job 2ₖ, A₁)*wₖ, where wₖ is the weight that a jobseekerₖ gives to attribute A₁. Thus, in one example, the following formula can be used to calculate the total similarity score TS of two job listings Job 1 and Job 2 utilizing the scores of multiple jobseekers: TS(Job 1, Job 2, A₁)=[s(1, Job 1₁, Job 2₁, A₁)*w₁]+[s(1, Job 1₁, Job 2₁, A₁)*w₁]+ . . . +[s(1, Job 1ₙ, Job 2ₙ, Aₙ)*wₙ], the total number of jobseekers that selected Job 1 and Job 2.

As discussed above, the total similarity score can also be normalized. Normalized similarity can be defined as TS_{N}=(TS₁₋₂/U_{Job1}+TS₁₋₂/U_{Job2})/2, where U_{Job1} is the number of jobseekers interested in Job 1, and U_{Job2} is the number of jobseekers interested in Job 2.

In addition, total affinity calculation can be provided to add the similarity scores for each of the attributes. For example, :The total affinity between Jobs[i] and Jobs[j] TA=TS(Job 1, Job 2, A₁)+TS(Job 1, Job 2, A₂)+ . . . +TS(Job 1, Job 2, Aₘ)

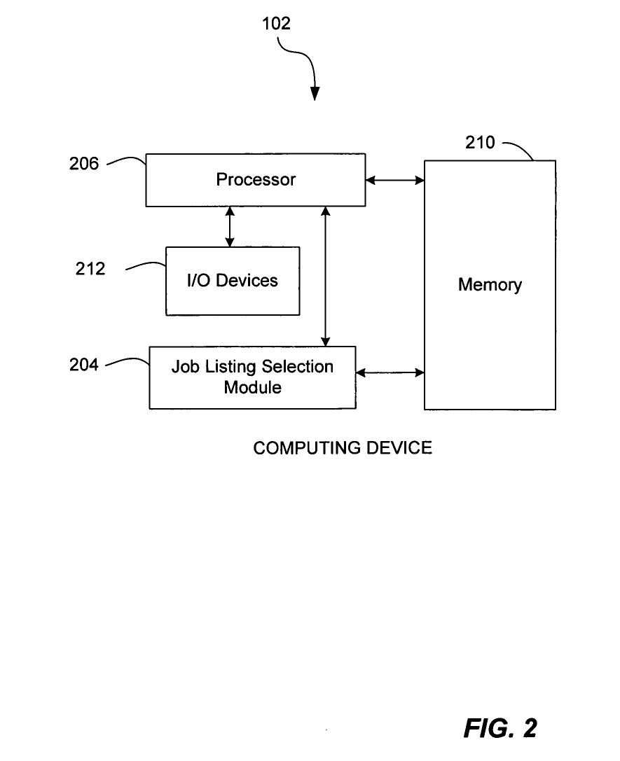

FIG. 2 illustrates a block diagram of an example of a computing device 102. Specifically, the computing device 102 may be employed by a jobseeker to select job listings from the job listing provider 114, transmit jobseeker information, or to receive affinity information. In one embodiment, the computing device 102 is implemented using a general-purpose computer or any other hardware or software equivalents. Thus, the computing device 102 generally comprises processor 206, memory 210, e.g., random access memory (RAM) and/or read only memory (ROM), job listing selection module 204, and various input/output devices 212, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a jobseeker input device (such as a keyboard, a keypad, a mouse, and the like, or a microphone for capturing speech commands)).

It should be understood that the job listing selection module 204 may be implemented as one or more physical devices that are coupled to the processor 206 through a communication channel. Alternatively, the job listing selection module 204 may be represented by one or more software applications (or even a combination of software and hardware, e.g., using application specific integrated circuits (ASIC)), where the software is loaded from a storage medium, (e.g., a magnetic or optical drive or diskette) and operated by the processor 206 in the memory 210 of the computing device 102. As such, the job listing selection module 204 (including associated data structures) of the present invention may be stored on a computer readable medium, e.g., RAM memory, magnetic or optical drive or diskette and the like.

The job listing selection module 204 can be utilized by a jobseeker to make job listing selections, such as applying for a job listing from an Internet website. In addition, the job listing selection module 204 can receive job listing affinity data from the server 106. The job listing selection module 204 can be configured to automatically make a selection decisions based on affinity data and recommendations received from the server 114.

The job listing selection module can be a computer application such as by way of non-limiting example an Internet browser, or any other network communication software or hardware that permits a jobseeker to interact with the server 106.

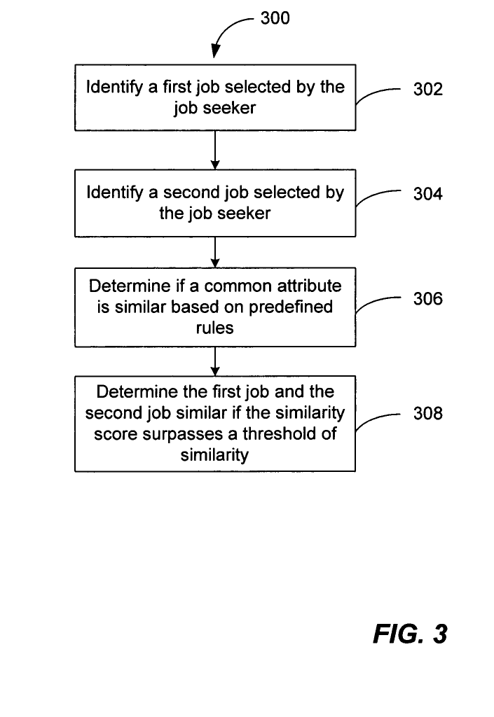

FIG. 3 illustrates a flow diagram of a process of determining job affinity based on jobs selected by a jobseeker. In one embodiment, the word “selected” means that the jobseekers applied for the first job listing and the second job listing. In another embodiment, the word “selected” means that the jobseekers viewed the first job listing and the second job listing. In yet another embodiment, the word “selected” means that the jobseekers rated the first job listing and the second job listing, thus an item is deemed selected based upon a flexible or application specific variety of user interaction events.

At process block 302, a first job selected by a jobseeker is identified. In one embodiment, the first job can be identified by accessing the jobseeker profile at the jobseeker database 518. The jobseeker profile can indicate all of the jobs that a jobseeker has viewed, applied for, or otherwise selected. In addition, the job attributes, can also be stored in the jobseeker profile. Alternatively, the job information can simply be a job identifier that references a job record in the job database 508. The process 300 continues to process block 304.

At process block 304, a second job selected by a jobseeker is identified. A second job that has been selected by the same jobseeker can be identified from the same jobseeker profile utilized to identify the first job. The process 300 continues to process block 306.

At process block 306, a similarity score that represents similarity between a first job attribute and a second job attribute is determined. The similarity between two attributes can be determined utilizing one or more methodologies. In one example, a first job attribute and a second job attribute can be deemed similar only if the corresponding values are identical. For example, if the attribute is Location, the Location for a first and a second job is only similar if the location for both jobs is “Chicago.” In another embodiment, the first job attribute and the second job attribute can be deemed similar if there is a match of the first job attribute and the second job attribute in a predefined relational table. In another embodiment, the first and the second attributes are similar based on heuristic models implemented by a system administrator, jobseekers, recruiters, or programmatically. For example, similarity of attributes can be established based on similarity of the text value. Two attributes values can be similar even when the attribute values are not identical. In one example, two locations can be deemed similar based on proximity. In another example, the predefined relational table can include locations that are similar even though the name of the location is not the same. Further, the table may indicate the level of similarity of the two attributes. For example, a location of San Francisco and a location of Berkley can have a higher similarity location score than a location of San Francisco in comparison with San Jose.

Alternatively, the level of selection can be utilized to determine a similarity score. For example, if the jobseeker viewed the first job and the second job, a low similarity score is assumed for both jobs. If the jobseeker applied for both jobs, however, a higher similarity score for the two jobs can be assumed. In addition, the similarity score can then be utilized in the aggregate with other similarity scores of other jobseekers. Thus, if a high number of jobseekers applied for the same two jobs, there is a greater probability that the two jobs are closely related, which can be reflected in the sum of similarity scores. The process 300 continues to process block 308.

At process block 308, the first job and the second job are established to share affinity if the first job attribute and the second job attribute were determined to be similar. A threshold of similarity can be established. In another embodiment, the threshold of similarity can be predefined by a jobseeker. For example, one jobseeker can establish a high threshold of similarity if the jobseeker only wants to view recommended jobs that have very close affinity to those job listings that the jobseeker has previously viewed or selected. Likewise, another jobseeker can establish a low threshold of similarity if the jobseeker wants to view recommended jobs that are loosely related to those job listings that the jobseeker has previously viewed or selected. In yet another embodiment, the threshold of similarity can be predefined according to the attributes being compared. Thus, in one example, the threshold of similarity can be established to be low for location, but high for the job title. This configuration can be useful for a jobseeker who is willing to relocate but has a high interest in finding a job listing with a specific job title.

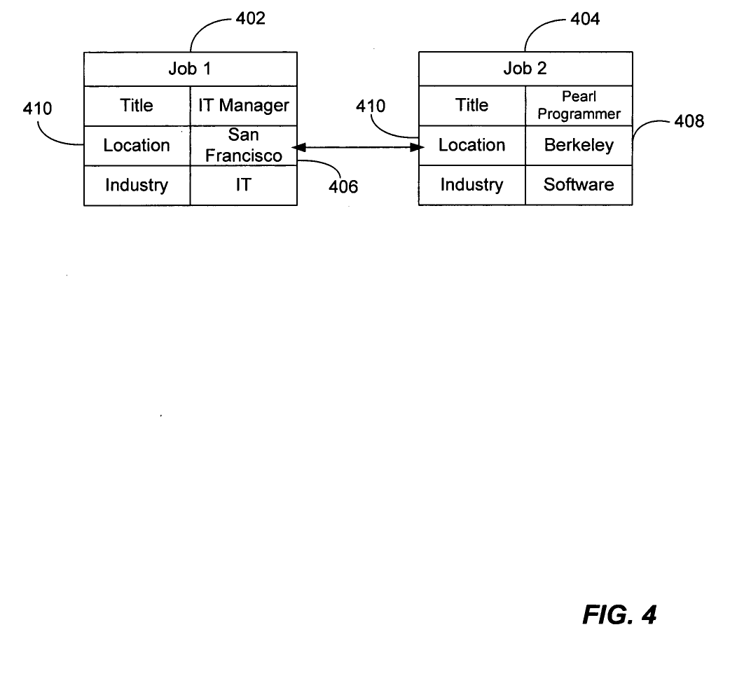

FIG. 4 illustrates two jobs selected by a jobseeker. An affinity relation can be established between a first job 402 and a second job 404. In one embodiment, the first job 402 and the second job 404 include the same attributes such as title location and industry. Of course, the values for each attribute can vary. In another embodiment, the first job 402 and the second job 404 can have different attributes but at least one attribute in common. The attribute in common can be utilized to establish the affinity relation between the first job 402 and the second job 404.

The first job 402 and the second job 404 may include a location attribute 410 which can be utilized as the basis for comparison. If the location attribute value 406 and the location attribute value 408 are deemed similar, then the first job 402 and the second job 404 can be deemed to have an affinity relation. For example, if by virtue of being in the same metropolitan area, location attribute value 406, San Francisco, is deemed similar to the location attribute value 408, Berkley, then the first job 402 and the second job 404 can be affiliated.

A similarity score between attribute value 406 and attribute value 408 can be determined depending on one or more factors. In one example, the similarity score can be a number between zero and one. In another example, the similarity score can be a number between one and one hundred. In another example, the similarity score can be any number. Moreover, a threshold of similarity can be established to determine when two jobs are related. For example, if the similarity score is greater than a predetermined threshold of similarity then first job 402 and second job 404 can be deemed affiliated.

Job location similarity can be defined in different ways. In one embodiment, a metro area code can be utilized to calculate location similarity such that if two jobs are located in the same metro area, the similarity score between the two jobs can be a high number. For example, the similarity score can be 1 in a scale from 0 to 1. If the two jobs are not in the same metro area, the similarity score can be low, such as 0 in a scale from 0 to 1.

In another embodiment, the location similarity can be calculated utilizing geo-codes. For example, using known algorithms and geoposition data of each of the two jobs locations, the distance between a first job location and a second job location can be determined. In one example, the location similarity score of two jobs can be calculated according to the formula s=1−min((Distance/Base Distance), 1), where the Distance is the distance between the first job location and the second job location. The Base Distance can be calculated according to the formula b=25+(0.6−Location Weight)*30, where the Location Weight is the weight a jobseeker assigned for a location attribute.

In yet another embodiment, the location similarity can be determined by executing a lookup operation of a relational table that includes location pairs corresponding to locations that are affiliated. The table can be built according to a uniformly applied formula used for all jobseekers and job listings. In another example, the table can be customized by a jobseeker.

Job title similarity can also be defined in multiple ways. In one embodiment, the job listing provider can utilize a list of standard job titles. When a new job listing is posted, the best fitting standard job title is applied to the new job listing. For example, new jobs with titles of “Programmer,” “Software Developer,” and “Computer Programming” may all be standardized to a title such as “Computer Programmer.” The set of standard job titles allows easily comparing two job titles and determining an accurate similarity score. As an example, in one embodiment, if two jobs match to the same standard job title, the similarity score can be 1 in a scale from 0 to 1. If the two job titles do not match, the similarity score assigned can be 0 in a scale from 0 to 1.

Thus, in order to standardize job titles, various methodologies can be utilized. In one example, standard titles are sorted by length or word count in ascending order. Each job title is matched to the standard titles in the sorted list such that the most descriptive (e.g., largest words count) standard job title is utilized.

Industry similarity can also be defined according to various methodologies. In one embodiment, a list of standard industries can be generated and utilize to assign the correct standard industry for new job listings. In another embodiment, a direct comparison of job industries between a first job and a second job can be conducted. If the industries match, then the similarity score can be 1 in a scale from 0 to 1. If the two job industries do not match, the industry similarity score assigned can be 0 in a scale from 0 to 1. In yet another embodiment, a similarity table with industry listings can be utilized such that similarity scores are predefined for pairs of job industries.

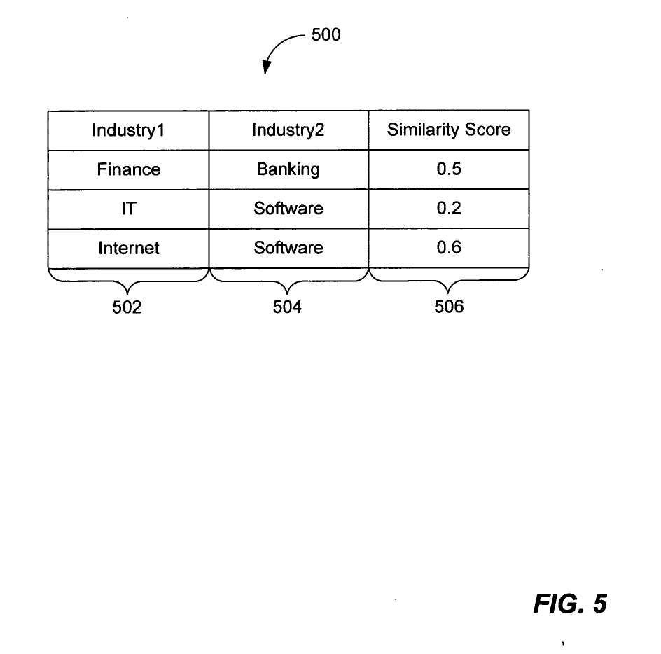

FIG. 5 illustrates an exemplary similarity table 500 of job industries. In one embodiment, the similarity table 500 includes a first industry column 502, a second industry column 504 and a similarity score column 506. A first job industry can be related to a second job industry according to a predefined similarity score. In one example, a job industry of Finance and a job industry of Banking can be established to have a similarity score of 0.5. Thus, when determining the industry similarity score of two jobs, one being in the Finance industry, and the second one in the Banking industry, the industry similarity score of those two jobs can be 0.5 according to table 500.

In another example, a job industry of IT and a job industry of Software can be established to have a similarity score of 0.5. In yet another example, a job industry of Internet and a job industry of Software can be established to have a similarity score of 0.5.

In one embodiment, the industry similarity score can be calculated by comparing a first job industry and a second job industry. If the industries match, then the industry similarity can be 1 in a scale from 0 to 1. If the industries do not match, a search can be performed in the similarity table 500 to look for the pair of industries and determine the similarity score. If the industry pair is not in the similarity table 500, then the similarity score is zero.

In another embodiment, the industry similarity score can be calculated by comparing a first job industry and a second job industry. If the industry pair is in the similarity table 500 then the industry similarity score between the first job and the second job is the similarity score corresponding to the industry pair in the similarity table 500.

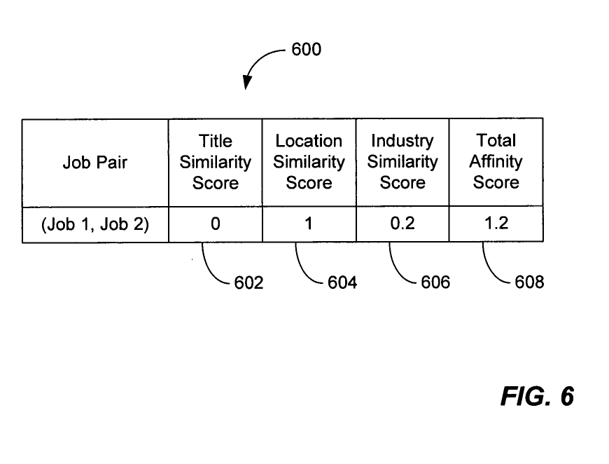

FIG. 6 illustrates an exemplary affinity table 600 with similarity scores for a job pair. The affinity for two jobs can be established based on the one or more attribute similarity scores. In one embodiment, the affinity of a first job and a second job can be established according to affinity table 600. The affinity table 600 includes a title similarity score 602, a location similarity score 604, and an industry similarity score 606. In one example, the similarity scores of the affinity table 600 are derived from the information of first job 402 and second job 404. As such, the title similarity score 602 is zero, since the title of the first job 402 is IT Manager, and the title of the second job 404 is Pearl Programmer. The location similarity score 604 is 1 since the location of the first job 402 is San Francisco, and the location of the second job 404 is Berkley.

Furthermore, the industry similarity score 606 can be calculated based on a predefined similarity score. In one example, the industry similarity table 500 can be utilized to derive the industry similarity score 606. Thus the industry similarity score 606 can be 0.2 since the industry of the first job 402 is IT, and the industry of the second job 404 is Software.

In addition, a total affinity score can be calculated based on the attributes similarity score. Thus, total affinity score 608 can be calculated by adding the title similarity score 602, the location similarity score 604, and the industry similarity score 606. In one example, the total affinity score 608 is 1.2 since the title similarity score 602 is zero, the location similarity score 604 is 1, and the industry similarity score 606 is 0.2.

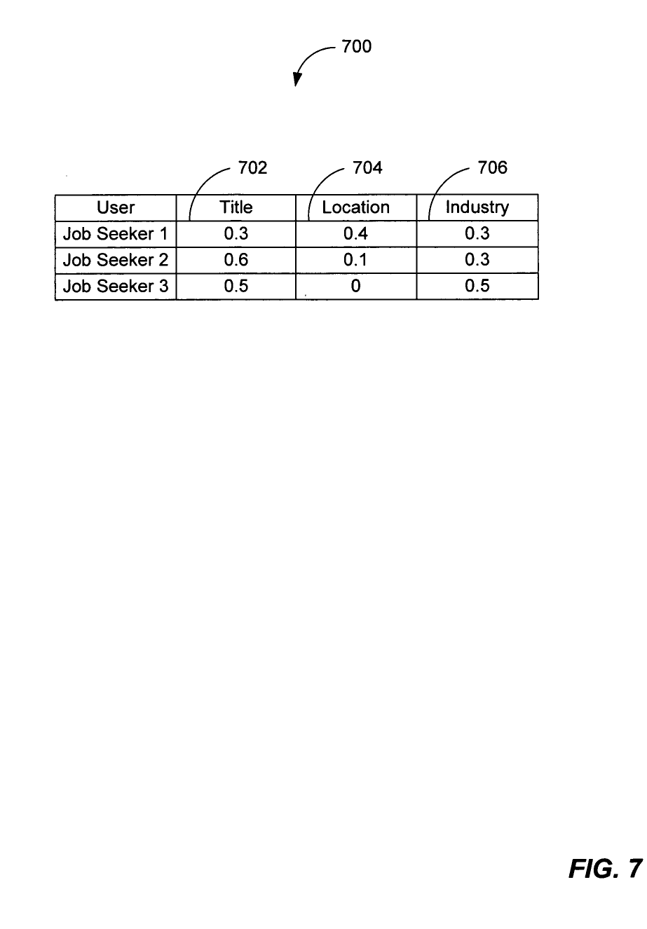

FIG. 7 illustrates exemplary attribute weights for a list of jobseekers. Each jobseeker can be provided with the ability to customize the importance of each attribute during the job search. Alternatively, the customization of the level of importance of each attribute can be provided by a system operator, administrator or programmatically. Thus, for example a jobseeker can give great importance to the location of the jobs that the jobseeker searches, and less importance to the industry. In that case, the jobseeker may give a low weight to the location and greater weight to the industry. In another example, a second jobseeker may give greater importance to the job title than the location of the job. As such, the second jobseeker may indicate a greater weight for the job title, and a low weight for the location of the job. As similarity scores are being established for each pair of jobs that a jobseeker has applied for, the weight that the jobseeker gives to each attribute can be applied to adjust the similarity score of each pair of jobs.

The weight table 700 illustrates the importance that each jobseeker gives to jobs attributes. In one embodiment, the total sum of the weights established by a jobseeker is one. Thus, a first jobseeker may assign 0.2 to the title weight 702, 0.4 to the location weight 704, and the 0.3 to the industry weight.

In one embodiment, the weights for each jobseeker are stored in the jobseeker database 118. The jobseeker database 118 contains jobseeker profiles that can include the jobseeker weight preferences.

FIG. 8 illustrates exemplary weighted similarity scores for a job pair. In one embodiment, the affinity of a first job and a second job can be established according to affinity table 800. The affinity table 800 includes a title weighted similarity score 802, a location weighted similarity score 804, and an industry weighted similarity score 806. In one example, the similarity scores of the affinity table 800 are derived from the similarity scores of affinity table 600 of FIG. 6 in combination with the weight information of the first jobseeker as illustrated in FIG. 5. Thus, the title weighted similarity score 802 can be calculated by multiplying the title similarity score times the title weight assigned by the first jobseeker. The location weighted similarity score 804 can be calculated by multiplying the location similarity score times the title weight assigned by the first jobseeker. The industry weighted similarity score 806 can be calculated by multiplying the industry similarity score times the industry weight assigned by the first jobseeker.

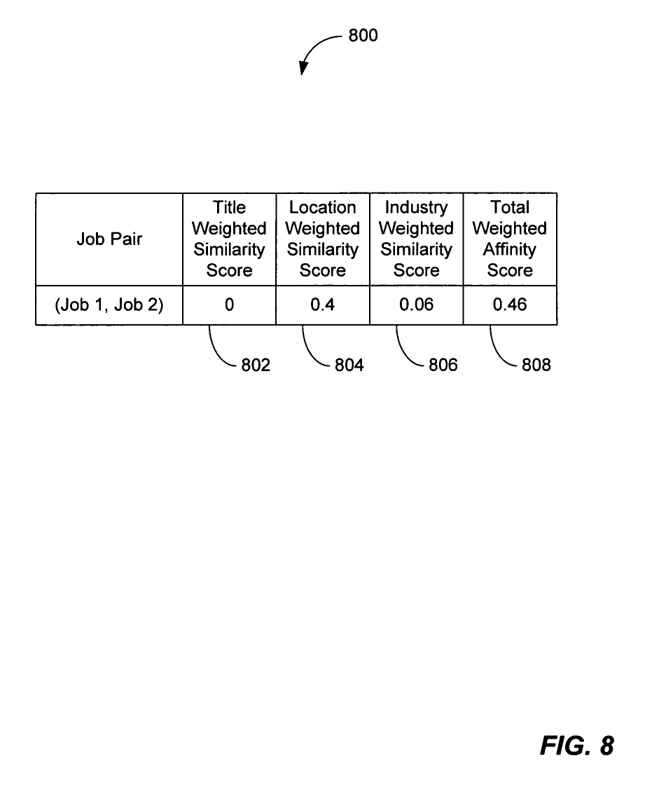

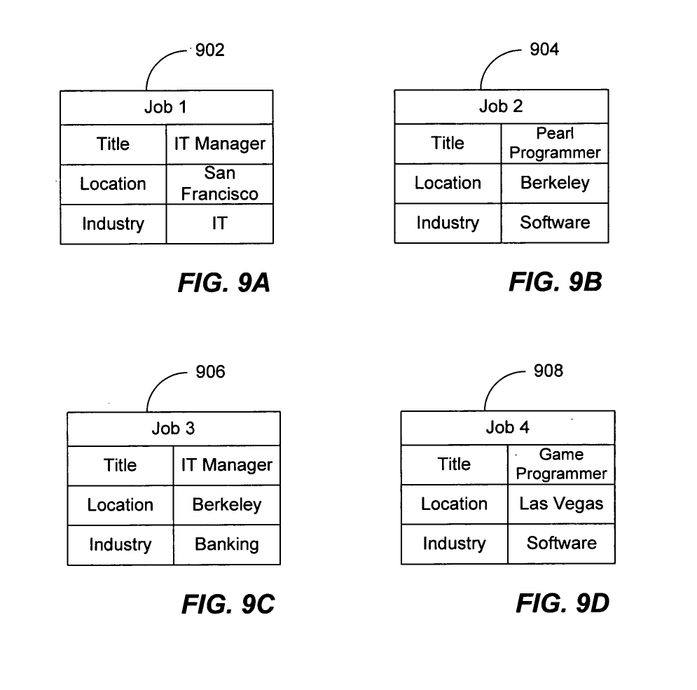

FIGS. 9A-9D illustrate exemplary jobs listed by the job listing provider. Any number of job listings can be provided by a job listing provider. For illustration purpose only, four jobs are depicted in FIG. 9: first job 902, second job 904, third job 906, and fourth job 908. As these jobs are listed by the job listing provider, and jobseekers apply for these jobs, similarity scores can be established based on jobseekers viewing, selection, interaction, or application for one or more of these jobs. The similarity scores can continue to be recalculated based on continuous and new jobseeker interaction. Thus, over time, the similarity scores can become increasingly more accurate because of the large number of jobseekers that can contribute to defining similarity and affinity relation of these jobs.

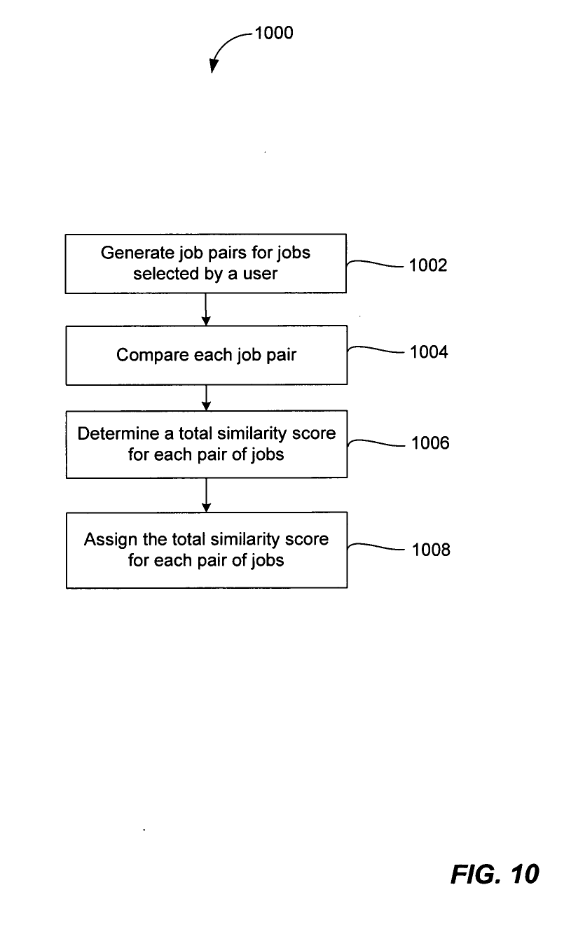

FIG. 10 illustrates a flow diagram for a process 1000 of determining job affinity based on jobs selected by a plurality of jobseekers. At process block 1002, job pairs are generated utilizing the jobs that a jobseeker selected. In one embodiment, all possible job pair combinations are generated. For example, if a jobseeker selected three jobs, Job 1, Job 2, and Job 3, the combination pairs would be (Job 1, Job 2), (Job 1, Job 3), (Job 2, Job 3). In another example, if the jobseeker selected two jobs, Job 1 and Job 2, the combination pars would be (Job 1, Job 2). In a further example, if a jobseeker selected Job 1, Job 2, Job 3, and Job 4, the combination pairs would be (Job 1, Job 2), (Job 1, Job 3), (Job 1, Job 4), (Job 2, Job 3), (Job 2, Job 4), and (Job 3, Job 4). The process 1000 continues to process block 1004.

At process block 1004, each job pair is compared. In one embodiment, only one attribute is utilized to determine the total similarity score. For example, if the job pair corresponds to two job listings having three attributes, Location, Title, and Industry, only the Location attribute can be utilized for the comparison. As discussed above, the similarity scores can further be adjusted to include the attribute weight. In another embodiment, all attributes are utilized for comparison in order to determine the total similarity score. The process 1000 continues to process block 1006.

At process block 1006, the total similarity score for each pair of jobs is determined. Once the similarity score for one or more attributes of a pair of jobs is determined, the total similarity score is calculated based on the attribute similarity scores. In one example, the total similarity score for a job pair is the sum of all attribute similarity scores. In another example, the total similarity score for a job pair is the product of all attribute similarity scores. In yet example, the total similarity score for a job pair is the sum of weighted attribute similarity scores. The process 1000 continues to process block 1008.

At process block 1008, once the total similarity score has been calculated for each pair of jobs, the similarity score is assigned to the pair of jobs and stored in a data repository. For example, the newly calculated scores can be stored the jobs database 122.

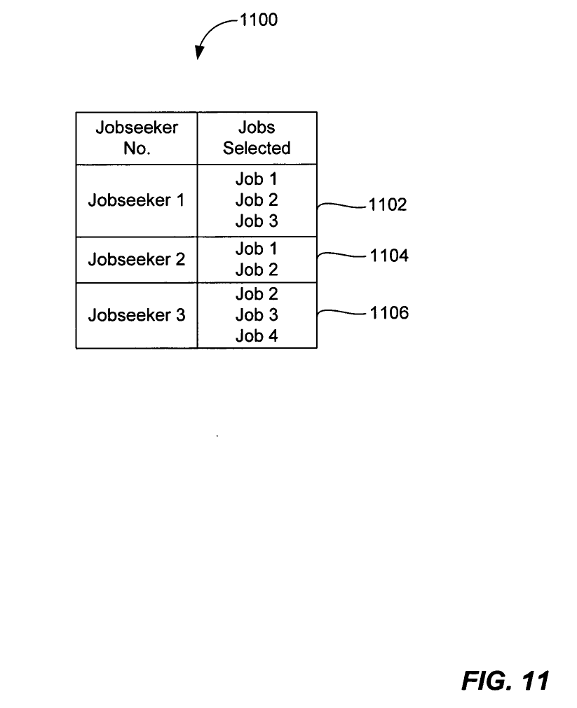

FIG. 11 illustrates an exemplary list of jobs 1100 selected by a plurality of jobseekers. According to the example illustrated in FIG. 11, each job seeker has selected one or more of the jobs illustrated in FIG. 9A-9D. A plurality of jobs 1102 comprises the first job 902, the second job 904, and the third job 906. A plurality of jobs 1104 comprises the first job 902, and the second job 904. A plurality of jobs 1106 comprises the second job 904, the third job 906, and the fourth job 908.

In one example, a first jobseeker applies for a plurality of jobs 1102, a second jobseeker applies for a plurality of jobs 1104, and a third jobseeker applies for a plurality of jobs 1106. In another example, a first jobseeker submits his resume for a plurality of jobs 1102, a second jobseeker his resume for a plurality of jobs 1104, and a third jobseeker his resume for a plurality of jobs 1106.

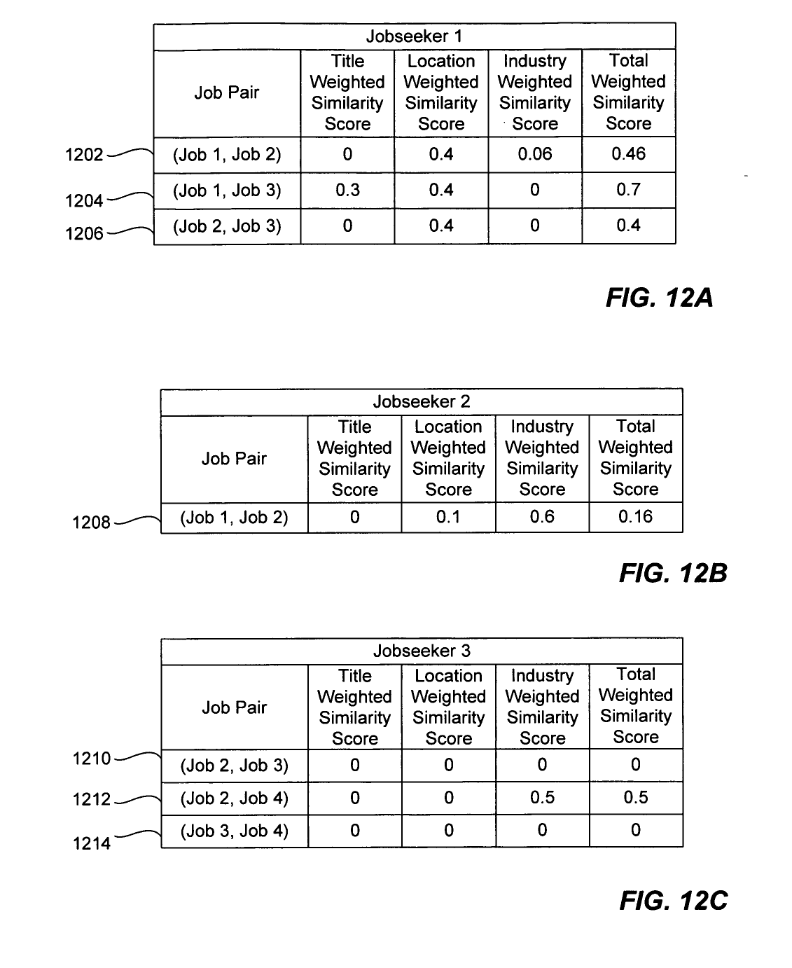

FIG. 12A illustrates exemplary similarity scores for job pair combinations for a first jobseeker. The similarity scores can be calculated as discussed above with reference to FIG. 6 and FIG. 8. Job pair 1202, job pair 1204, and job pair 1206, include weighted similarity scores for the title, location, and industry, as well as a total weighted similarity score. FIG. 12B illustrates exemplary similarity scores for job pair combinations for a second jobseeker. Job pair 1208 also includes weighted similarity scores for the title, location, and industry, as well as a total weighted similarity score. Finally, FIG. 12C illustrates exemplary similarity scores for job pair combinations for a third jobseeker. Job pair 1210, job pair 1212, and job pair 1214 also include weighted similarity scores for the title, location, and industry, as well as a total weighted similarity score.

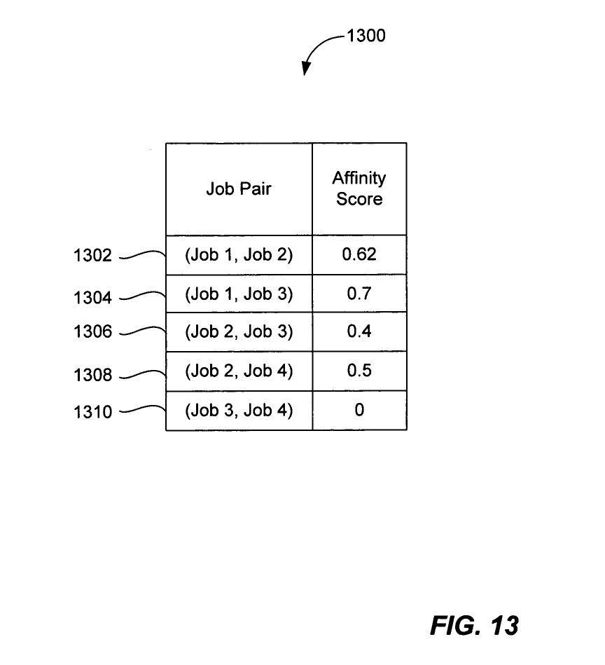

FIG. 13 illustrates an exemplary job pair affinity table. The affinity table can be constructed from utilizing the job pairs of all jobseekers. For example, according to the job pairs generated in FIG. 12 above, the total weighted similarity score for each job pair can be utilized to determine the affinity score of each job pair.

In one embodiment, the affinity score of a given job pair can be a sum of total weighted similarity scores for the job pair. Therefore, in one example, a job pair 1302 corresponding to pair (Job 1, Job 2), can have value that is the sum of the total similarity scores of all jobseekers who have applied to Job 1 and Job 2. By way of example, the job pairs 1202 and 1208 are job pairs (Job 1, Job 2) for which a total similarity score has been calculated. Job pair 1202 corresponds to a first jobseeker, and job pair 1208 corresponds to a second jobseeker. Thus, job pair affinity score 1302 can have a value that is the sum of values of the total similarity score of job pairs 1202 and 1208. The job pair affinity score represents the affinity between Job 1 and Job 2 according to all jobseekers that have applied to both jobs.

In another example, job pair affinity score 1304 includes the total similarity score of job pair 1204 corresponding to a first jobseeker. Because no other jobseekers have applied to both jobs, Job 1 and Job 3. The only pair having a total weighted similarity score is job pair 1204. The weighted similarity score of job pair 1204 is used as the affinity score for job pair 1304. If another jobseeker applies or selects Job 1 and Job 3, a new pair with a total similarity score can be introduced, and the job pair affinity score 1304 can then be recalculated.

In another example, a job pair affinity score 1306 corresponding to pair (Job 2, Job 3) can have a value that is the sum of the total similarity scores of all jobseekers who have applied to both Job 1 and Job 3. By way of example, the job pairs 1206 and 1210 are job pairs (Job 2, Job 3) for which a total weighted similarity score has been calculated. Job pair 1206 corresponds to the first jobseeker, and job pair 1210 corresponds to the third jobseeker. Thus, job pair affinity score 1306 can have a value that is the sum of values of the total weighted similarity score of job pairs 1206 and 1210. As such, the job pair affinity score 1306 represents the affinity between Job 2 and Job 3 in accordance with the similarity scores provided by the jobseekers that have applied to both jobs.

In yet another example, job pair affinity score 1308 and job pair affinity score 1310 include the total similarity score of job pairs 1212 and 1214 respectively.

Only the third jobseeker has selected both jobs Job 2 and Job 4. Therefore, the total weighted similarity score of job pair 1212 can be used as the value for job pair 1308. Likewise, because the third jobseeker has selected both jobs Job 3 and Job 4, job pair 1214 can be used as the value for job pair affinity score 1310.

In another embodiment, the total score can be averaged. For example, job pair affinity score 1302 can have a value that is the average of the values of the total weighted similarity score of job pairs 1202 and 1208. Other methodologies can also be utilized to calculate the affinity score based on the total similarity scores of each pair of each jobseeker. Thus, normalization, ceiling, floor, mean, and other operations of the total similarity scores can be performed in order to obtain an affinity score.

While the apparatus and method have been described in terms of what are presently considered the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. In addition, attributes utilized in some examples, the number of jobseekers or jobseekers, and other particular details are disclosed for discussion and exemplary purposes only. The present disclosure includes any and all embodiments of the following claims.

1. A method of establishing affinity of job listings, comprising:
identifying a first job listing for which a jobseeker has applied, the first job listing having a first job attribute;
identifying a second job listing for which the jobseeker has applied, the second job listing having a second job attribute;
determining a similarity score that represents a similarity between the first job attribute and the second job attribute by comparing the first job attribute value and the second job attribute value; and
affiliating the first job listing and the second job listing if the similarity score is higher than a predefined threshold level.

2. The method of claim 1, further comprising recommending said second job listing to a new jobseeker when the new jobseeker applies for the first job listing, if the similarity score is higher than the predefined threshold level.

3. The method of claim 1, further comprising recommending the first job listing to a new jobseeker when the new jobseeker applies for the second job listing, if the similarity score is higher than the predefined threshold level.

4. The method of claim 1, further comprising generating a weight corresponding to the first and the second attribute and multiplying the weight by the similarity score.

5. The method of claim 1, further comprising multiplying the similarity score by a weight defined by the jobseeker.

6. The method of claim 1, further comprising receiving said predefined threshold level as established by the jobseeker.

7. The method of claim 1, further comprising receiving said predefined threshold level as established by a system operator.

8. The method of claim 1, further comprising establishing said predefined threshold level.

9. The method of claim 1, wherein the predefined threshold level is zero.

10. The method of claim 1, wherein the first job attribute value is a first job listing location, and the second job attribute value is a second job listing location.

11. The method of claim 1, wherein the first job attribute value is a first job listing title, and the second job attribute value is a second job listing title.

12. The method of claim 1, wherein the first job attribute value is a first job jobseeker, and the second job attribute value is a second job jobseeker.

13. The method of claim 1, wherein if the first job attribute value and the second job attribute value are identical the similarity score is assigned a value of one.

14. The method of claim 1, wherein if the first job attribute value and the second job attribute value are not identical the similarity score is assigned a value of zero.

15. The method of claim 1, wherein if the first job attribute value and the second job attribute value are not identical the similarity score is assigned a value between zero and one.

16. The method of claim 1, further comprising utilizing a predefined similarity score as the similarity score, wherein the predefined similarity score is indicative of the similarity of a value pair in a similarity table, wherein the first job attribute value is equivalent to a first element of the value pair, and the second job attribute value is equivalent to a second element of the value pair.

17. A system that establishes affinity of job listings, comprising:
a jobs database that includes a first job listing for which a jobseeker has applied, the first job listing having a first job attribute, the jobs database further including a second job listing for which the jobseeker has applied, the second job listing having a second job attribute; and
an affinity module configured to compare the first job attribute and the second job attribute to determine a similarity score that represents a similarity between the first job attribute and the second job attribute, wherein the affinity module further affiliates the first job listing and the second job listing if the similarity score is higher than a predefined threshold level.

18. The system of claim 17, wherein if the affinity module determines that the similarity score is higher than a predefined threshold level, the second job listing can be recommended to a new jobseeker when the new jobseeker applies for the first job listing.

19. The system of claim 17, wherein if the affinity module determines that the similarity score is higher than a predefined threshold level, the first job listing can be recommended to a new jobseeker when the new jobseeker applies for the second job listing.

20. The system of claim 17, wherein the affinity module is configured to generate a weight corresponding to the first and the second attribute and multiplying the weight by the similarity score.

21. The system of claim 17, wherein the affinity module further multiplies the similarity score by a weight defined by the jobseeker.

22. The system of claim 17, wherein the predefined threshold level is established by the jobseeker.

23. The system of claim 17, wherein the predefined threshold level is established by a system operator.

24. The system of claim 17, wherein the affinity module is further configured to establish the predefined threshold level.

25. The system of claim 17, wherein the first job attribute is a first job listing location, and the second job attribute is a second job listing location.

26. The system of claim 17, wherein the first job attribute is a first job listing title, and the second job attribute is a second job listing title.

27. The system of claim 17, wherein the first job attribute is a first job listing industry, and the second job attribute is a second job listing industry.

28. The method of claim 17, wherein the first job attribute is a first job jobseeker, and the second job attribute is a second job jobseeker.

29. The system of claim 17, further comprising a computer server that hosts an Internet website wherein the first job listing and the second job listing are posted.

30. The system of claim 17, wherein if the first job attribute and the second job attribute are identical the similarity score is assigned a value of one.

31. The system of claim 17, wherein if the first job attribute and the second job attribute are not identical the similarity score is assigned a value of zero.

32. The system of claim 17, wherein the affinity module determines the similarity score according to a similarity table that indicates a predefined similarity score for at least one pair of job attributes, wherein if the if the at least one pair of job attributes are the first job attribute and the second job attribute, the affinity module assigns the value of the predefined similarity score to the similarity score.

33. The system of claim 17, wherein the predefined threshold level is zero.

34. A method of establishing affinity of job listings, comprising:
identifying a first job listing for which a jobseeker has selected, the first job listing having a first job primary attribute and a first job secondary attribute;
identifying a second job listing for which the jobseeker has selected, the second job listing having a second job primary attribute and a second job secondary attribute;
comparing a first job primary attribute value and a second job primary attribute value to determine a primary similarity score that represents a similarity between the first job primary attribute and the second job primary attribute, wherein the first job primary attribute value corresponds to the first job primary attribute, wherein the second job primary attribute value corresponds to the second job primary attribute;
comparing a first job secondary attribute value and a second job secondary attribute value to determine a secondary similarity score that represents a similarity between the first job secondary attribute and the second job secondary attribute, wherein the first job secondary attribute value corresponds to the first job secondary attribute, wherein the second job secondary attribute value corresponds to the second job secondary attribute; and
affiliating the first job listing and the second job listing if the sum of the primary similarity score and the secondary similarity score is higher than a predefined threshold level.

35. The method of claim 34, wherein the first job primary attribute is a first job listing location, and the second job primary attribute is a second job listing location.

36. The method of claim 34, wherein the first job secondary attribute is a first job listing title, and the second job secondary attribute is a second job listing title.

37. The method of claim 34, further comprising multiplying the first similarity score by a first weight defined by the jobseeker, and multiplying the second similarity score by a second weight defined by the jobseeker.

38. The method of claim 34, further comprising comparing a first job tertiary attribute value and a second job tertiary attribute value to determine a tertiary similarity score that represents a similarity between a first job tertiary attribute and a second job tertiary attribute, wherein the first job tertiary attribute is part of the first job listing, wherein the second job tertiary attribute is part of the second job listing, wherein the first job primary attribute value corresponds to the first job primary attribute, wherein the second job primary attribute value corresponds to the second job primary attribute, and wherein the first job listing and the second job listing are affiliated if the sum of the primary similarity score, the secondary similarity score, and the tertiary similarity score is higher than a predefined threshold level.

39. The method of claim 34, wherein the first job tertiary attribute is a first job listing industry, and the second job tertiary attribute is a second job listing industry.

40. The method of claim 34, further comprising receiving the first weight and the second weight as established by the jobseeker.

41. The method of claim 1, further comprising generating a weight corresponding to the first and the second attribute and multiplying the weight by the similarity score.

42. The method of claim 34, further comprising calculating an affinity score representative of an affinity between the first job listing and the second job listing, wherein the affinity score is calculated by adding a weighted primary similarity score and a weighted secondary similarity score, wherein the weighted primary similarity score is calculated by multiplying the first weight times the primary similarity score, wherein the weighted secondary similarity score is calculated by multiplying a second weight times the secondary similarity score.

43. The method of claim 34, further comprising recommending the second job listing to a new jobseeker when the new jobseeker applies for the first job listing, if the sum of the primary similarity score and the secondary similarity score is higher than the predefined threshold level.

44. The method of claim 34, further comprising recommending the first job listing to a new jobseeker when the new jobseeker applies for the second job listing, if the sum of the primary similarity score and the secondary similarity score is higher than the predefined threshold level.

45. The method of claim 34, further comprising receiving said predefined threshold level as established by the jobseeker.

46. The method of claim 34, further comprising receiving said predefined threshold level as established by a system operator.

47. The method of claim 34, further comprising establishing said predefined threshold level.
